(19) United States
(12) Patent Application Publication
(10) Pub. No.: US 2015/0031325 A1
(43) Pub. Date: Jan. 29, 2015

(54) EMERGENCY CALL APPARATUS OF MOBILE TERMINAL AND METHOD THEREOF

(71) Applicant: Electronics and Telecommunications Research Institute, Daejeon-si (KR)

(72) Inventors: Jae-Doo HUH, Daejeon-si (KR); Jung-Sik SUNG, Daejeon-si (KR); Kyung-Sup KWAK, Incheon-si (KR); Sang-Do LEE, Seoul (KR)

(73) Assignee: Electronics and Telecommunications Research Institute, Daejeon-si (KR)

(21) Appl. No.: 14/204,569

(22) Filed: Mar. 11, 2014

(30) Foreign Application Priority Data
Jul. 23, 2013 (KR) 10-2013-0086946

(51) Int. Cl. H04W 4/22

(52) U.S. Cl. CPC H04W 4/22
USPC 455/404.2

(57) ABSTRACT

An emergency call apparatus of mobile terminal and method thereof. The emergency call apparatus may include a location identifier to identify a location of a user, and generate location information of the user; an emergency situation manager to identify both voices and movements of the user, determine whether an emergency situation is occurring based on the identified voices and movements, generate an emergency situation alerting signal based on the determination result, and collect surrounding situation sounds generated around the user; and a controller to notify a situation room of the occurrence of the emergency situation based on the emergency situation alerting signal, and transfer the location information of the user and the surrounding situation sounds of the user to the situation room.

### CROSS-REFERENCE TO RELATED APPLICATION(S)

This application claims priority to and the benefit of Korean Patent Application No. 10-2013-0086946, filed on Jul. 23, 2013, in the Korean Intellectual Property Office, the entire disclosure of which is incorporated herein by reference for all purposes.

### BACKGROUND

1. Field

The following description relates to technology that detects an emergency and executes an emergency call, more specifically, an emergency rescue request for an emergency detected by a mobile terminal.

2. Description of the Related Art

Lately, frequent incidents of violent crimes targeting weak people of society have been occurring. To handle such emergencies, various ways have been suggested to increase public peace, such as patrol intensification, etc. However, realistically, budget and human resources are finite, therefore effective responses when emergencies occur may be limited. If emergencies or rescue requests are immediately dispatched when those emergencies occur, damage from emergencies that threaten a person's life and safety can be minimized.

A mobile terminal provided just an exclusive communication function, such as a simple call function, in the past; however, recently, as communication technology is quickly being developed, the mobile terminal is developing to a level of a smartphone that provides various applications and additional services. Due to such developments, distribution rate of the mobile terminal, such as cell phones, has also increased so that the mobile terminal has become one of belongings many people always carry. Thus, technology is being developed to handle emergencies by using mobile terminals carried by many people.

Equipped with a communication interface that can transfer and receive messages or data, the mobile terminal can transfer an emergency call signal or a rescue request to a police station or other places if it identifies the emergency. To implement those functions, mobile terminal manufacturers or a government apply emergency call functions to the mobile terminal. Korean Unexamined Patent Publication No. 10-2010-0110203 discloses an emergency alert system and method thereof using a wireless communication terminal. The Korean Unexamined Patent Publication No. 10-2010-0110203 is a patent of an emergency alerting system and method thereof using an emergency alerting device connected to the wireless communication terminal, in order to report the emergency of a wireless communication terminal owner, to record and transmit a site situation through the wireless communication terminal, and to try to call a preset number and transmit live sounds from the site. However, in such cases, emergency requests can only be dispatched if victims themselves perform some operations, such as pressing a button, or touching a display, etc., to report the fact that an emergency has occurred. Thus, if the victims are incapable of personally operating the mobile terminal in an emergency situation, it is impossible to implement the emergency call, which is a weak point.

### SUMMARY

The following description relates to an emergency call apparatus and method thereof to, when the user gets involved in the emergency situation, automatically identify an occurrence of the emergency situation, automatically make an emergency call, and automatically report a location of the user to a situation room, through movement patterns and voices of the user based on a mobile terminal without the user's special operations, in order to monitor the emergency call situation at a remote distance, and quickly respond to the emergency situation, thereby minimizing damage to the user.

In one general aspect, an emergency situation apparatus of a mobile terminal includes a location identifier to identify a location of a user, and generate location information of the user; an emergency situation manager to identify both voices and movements of the user, determine whether an emergency situation is occurring based on the identified voices and movements, generate an emergency situation alerting signal based on the determination result, and collect surrounding situation sounds generated around the user; and a controller to notify a situation room of the occurrence of the emergency situation based on the emergency situation alerting signal, and transfer the location information of the user and the surrounding situation sounds of the user to the situation room. The emergency situation manager may compare the identified voices of the user and preset emergency situation phrase information, identify an emergency situation phrase, and determine whether the emergency situation is occurring through the identified emergency situation phrase. In addition, the emergency situation manager may compare the identified movements of the user and preset user pattern information, and in response to the comparison result that movements of a different pattern compared to the preset user pattern information are detected among the movements of the user within a short time, determine that the emergency situation is occurring.

In response to the occurrence of the emergency situation, the controller may turn on either a microphone or a transmitter of the mobile terminal, and turn off a speaker and a receiver of the mobile terminal. By those operations, the mobile terminal is capable of avoid leaking unnecessary sounds through the receiver or the speaker during the emergency call process. In addition, the location identifier may continuously store the location information of the user, and in response to not identifying the location of the user, transfer the location information of the user, which is most recently identified, to the controller. The controller may, in the background, execute processes of identifying the situation room of the occurrence of the emergency situation, and transferring the location information of the user and the surrounding situation sounds of the user to the situation room, so that the mobile terminal is capable of externally hiding any sign of executing processes of the emergency call.

In another general aspect, an emergency situation method of a mobile terminal may include identifying, a location of a user, and generating location information of the user; identifying both voices and movements of the user; determining whether an emergency situation is occurring based on the identified voices and movements of the user; and in response to determining that the emergency situation is occurring, notifying a situation room of the occurrence of the emergency situation, and transferring the location information of the user and the surrounding situation sounds of the user to the situation room. The determining of whether the emergency situation is occurring based on the identified voices and movements of the user may further include comparing the identified voices of the user and preset emergency situation phrase information, and identifying an emergency situation phrase; and in response to identification of the emergency situation phrase, comparing the identified movements of the user and preset user pattern information, and detecting movements of a different pattern compared to the preset user pattern information among the movements of the user within a short time.

Other features and aspects may be apparent from the following detailed description, the drawings, and the claims.

### BRIEF DESCRIPTION OF THE DRAWINGS

FIG. 1 is a diagram illustrating an example of an emergency call apparatus of a mobile terminal according to an exemplary embodiment.

FIG. 2 is a diagram illustrating an example of a data flow of an emergency call apparatus of a mobile terminal according to an exemplary embodiment.

FIG. 3 is a diagram illustrating an example of an emergency call method of a mobile terminal according to an exemplary embodiment.

FIG. 4 is a diagram illustrating an example of a response method when receiving an emergency call of a mobile terminal according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

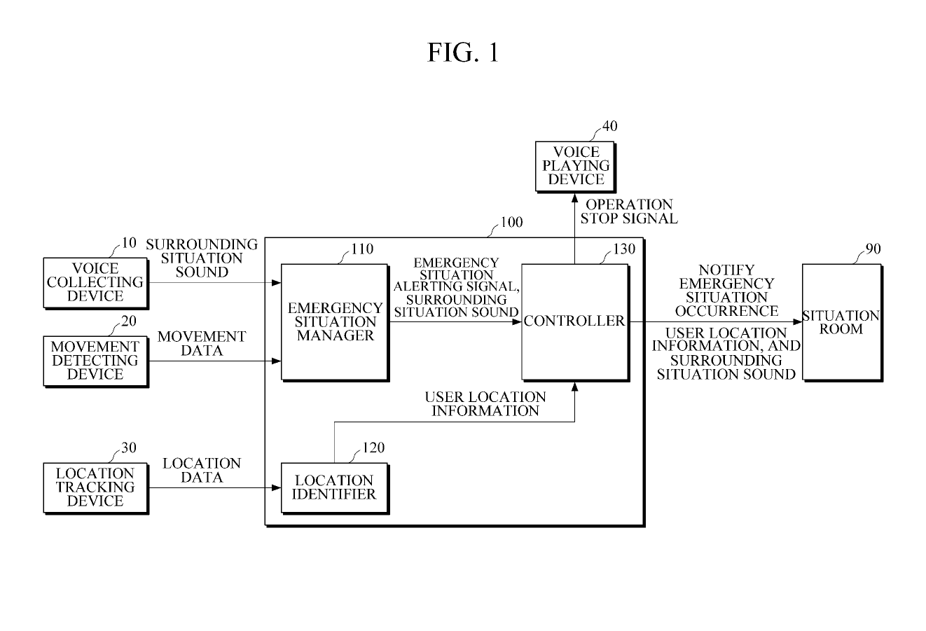

FIG. 1 is a diagram illustrating an example of an emergency call apparatus of a mobile terminal according to an exemplary embodiment.

Referring to FIG. 1, an emergency call apparatus 100 of a mobile terminal includes an emergency situation manager 110, a location identifier 120, and a controller 130 according to an exemplary embodiment.

The emergency situation manager 110 may analyze surrounding situation sounds received from a voice collecting device 10, and identify a voice signal from surrounding sound data. The voice collecting device 10, which collects the surrounding voice data, may use a transmitter that is equipped in the mobile terminal, or use an additional microphone. The surrounding situation sounds may indicate every collected sound and noise from around the mobile terminal, wherein the collected surrounding situation sounds may represent every sound generated around a user who is carrying the mobile terminal. The emergency situation manager 110 may, in the background, continuously receive every sound, which is generated from the surroundings, from the voice collecting device 10, analyze the received surrounding situation sounds, and identify a voice signal included in the received surrounding situation sound.

Then, the emergency situation manager 110 may extract a phrase regarding an emergency situation from the identified voice signal. The voice signal, which is identified in the emergency situation manager 110, may include a plurality of phrases expressed by a user or other people in possession of the mobile terminal. The emergency situation manager 110 identifies a phrase with respect to the emergency situation among the generated plurality of the phrases. Among the generated plurality of the phrases, a method of identifying the phrase with respect to the emergency situation is comparing emergency situation phrase information, which is stored in advance in the emergency situation manager 110, and the expressed plurality of phrases. The emergency situation phrase information stored in advance may be input directly by a user, or be a basic setting. For example, if phrases, such as ‘help me’ and ‘save me’, are stored in the emergency situation phrase information, the emergency situation manager 110 checks whether there are phrases corresponding to the phrases ‘help me’ or ‘save me’ among the expressed plurality of phrases, and identifies the phrase related to the emergency situation.

If an emergency situation phrase is identified, the emergency situation manager 110 determines that an emergency situation has happened to the user who is in possession of the mobile terminal, and may generate the emergency situation alerting signal to transfer it to the controller 130. Also, if the occurrence of an emergency situation is determined, the emergency situation manager 110 may store the sounds being transmitted of the surrounding environment in a storage device equipped in the emergency situation manager 110, and transfer the received surrounding situation sounds to the controller 130 together with the emergency situation alerting signal. If the phrase with respect to the emergency situation is not identified, the emergency situation manager 110 may delete the identified voice signal.

In addition, the emergency situation manager 110 may analyze movement data received from a movement detecting device 20, and identify a movement pattern of the user, who is carrying the mobile terminal. The movement detecting device 20 may include an accelerometer and a gyro sensor equipped in the mobile terminal, which are used to detect movements of the mobile terminal. The movement detecting device 20 may continuously measure the movements of the mobile terminal, and transfer the movement data to the emergency situation manager 110.

The emergency situation manager 110 may identify the movements of the user who is carrying the mobile terminal based on the movement data measured by the movement detecting device 20. Also, the emergency situation manager 110 may determine whether the user's movements are unusual, by comparing the user's pattern information stored in advance, and the identified movements of the user. The user's pattern information stored in advance is a standard to determine whether or not the user's present movement is normal, compared to the mobile terminal's movement measured through the movement detecting device 20. The user's pattern information may be externally input in advance, and may be stored after the movement detecting device 20 measures and learns a movement of the user. The emergency situation manager 110 compares the user's movement, identified through the movement detecting device 20, and the pattern information of the user, and if the user's movement is determined to be excessively different from the normal movement pattern within a short time, the emergency situation manager 110 may determine that an emergency situation has occurred to the user.

If an emergency situation phrase is identified through the voice collecting device 10, or an unusual movement is identifies through the movement detecting device 20, the emergency situation manager 110 may recognize that an emergency situation has occurred to the user. The two ways described above may be applied independently or complementarily applied. At first, if an emergency situation phrase is identified through the voice collecting device 10, the emergency situation manager 110 may determine whether the user's movement is unusual, which is identified through the movement detecting device 20. If the unusual movement is not detected, it may be determined that the emergency situation phrase is wrong, which is identified through the voice collecting device 10, or may be determined that the emergency situation phrase is identified regardless of the actual emergency situation occurrence, so that the emergency situation manager 110 may stop any emergency situation response action. On the other hand, if the emergency situation phrase is identified through the voice collecting device 10, and the unusual movement of the user is detected through the movement detecting device 20, the emergency situation manager 110 may determine that an emergency situation has occurred to the user, and transfer the emergency situation alerting signal to the controller 130.

The location identifier 120 may identify the present location of the user carrying the mobile terminal based on the mobile terminal's location data received from a location tracking device 30, such as a Global Positioning System (GPS), which is equipped in the mobile terminal, and transfer the identified location information of the user to the controller 130. In addition, the location identifier 120 may continuously store location information of the user. According to an exemplary embodiment, because the user may go indoors, or enter areas with severe disturbance to satellite electric waves, and the like, the present location of the user may not be detected normally by the location tracking device 30. Thus, by providing not only the user's present location information, but also the user's latest location information normally confirmed, the location identifier 120 may provide the closest approximate location information of the user even when the user's current location is unclear.

If the emergency situation alerting signal is received from the emergency situation manager 110, the controller 130 may take action in response to the emergency situation occurrence. If the emergency situation alerting signal is received, the controller 130 may notify the situation room 90, which is preset, of the emergency situation occurrence through a communication interface of the mobile terminal. The preset situation room 90 may be where notification of the emergency situation occurrence is sent, and where a signal for help is transferred, including public agencies in charge of public peace, such as a police station, a police substation, or emergency dispatch. Also, the controller 130 may notify the emergency situation occurrence to numbers, such as the user's home or parents' home phone number, which were directly input by the user.

The controller 130 may send notification of the emergency situation occurrence, and transfer the user's location information, which is received from the location identifier 120, to the situation room 90 at the same time. The user's location information is greatly important for rescuing the user who is in the emergency situation. The controller 130 may effectively take action in response to the emergency situation by providing the user's location information while sending notification of the emergency situation occurrence. Any communication interface among a call connection, a Short Message Service (SMS), and a data connection may be used when notifying the situation room 90 of the emergency situation occurrence and the user's location information.

Also, the controller 130 may transfer the surrounding situation sounds, which are received from the emergency situation manager 110, to the situation room 90, together with the user's location information. The situation room 90 can more effectively respond to the emergency situation involving the user through the received surrounding sounds. The surrounding situation sounds may be transferred by connecting the voice call to the situation room 90 through the mobile communication interface that is equipped in the mobile terminal. If the emergency situation alerting signal is received from the emergency situation manager 110, the controller 130 may make a voice call connection to the situation room 90 that is preset. When the controller 130 tries to make the voice call connection to the situation room 90, only microphone function of the mobile terminal is operated, and a speaker function is stopped. By those operations, during the process in which the surrounding situation sounds of the user are transferred to the situation room 90, the controller 130 may avoid transferring voices generated from the situation room 90 to the user's location through the mobile terminal. That is because an assailant may become aware that the mobile call is connected to the situation room 90 if any sound is generated from the mobile terminal. Thus, the controller 130 may stop the speaker function while the call is connected.

In addition, if it is determined that a user is involved in an emergency situation based on the received emergency situation alerting signal, the controller 130 may take the above-described action, and control the mobile terminal hide any signs that show the user's mobile is taking the above-described action. In other words, when the emergency situation occurs, the emergency call apparatus 100 of the mobile terminal may take actions, such as notifying the situation room 90 of the emergency situation occurrence and the user's location, and transferring the surrounding situation sounds to the situation room 90 through the call connection. However, the controller 130 may never display those operations being operated on the mobile terminal, and just execute those operations in the background so that the assailant cannot become aware that the emergency call is in progress. For example, although the mobile terminal takes action in response to the emergency situation occurrence that is described above, such action is executed in the background so that various functions of the mobile terminal can be normally used while hiding the fact that the emergency call is in progress, and showing the same as normal standby status.

If an incoming call is received in a state where the mobile terminal has identified the emergency situation occurrence, the controller 130 may automatically receive the call and transfer the emergency situation occurrence to a caller without an incoming call ringtone. Also, the controller 130 may enable the caller to monitor the surrounding situation sounds of the site by turning on the microphone, but the speaker off. In addition, the controller 130 may transfer the user's present location to the caller, thus enabling the caller to discern the user's exact location.

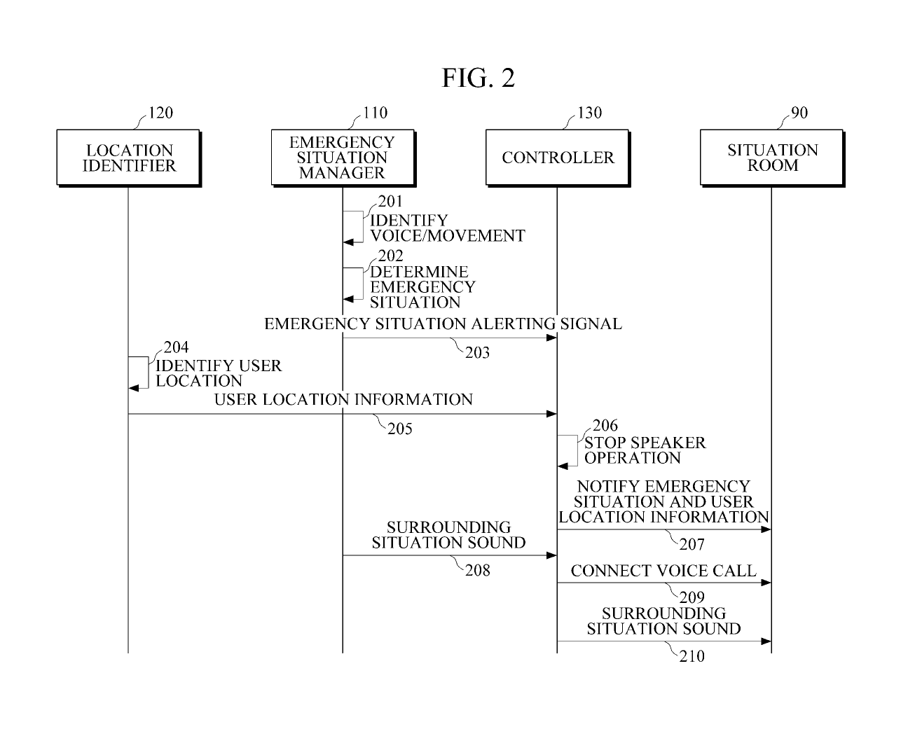

FIG. 2 is a diagram illustrating an example of a data flow of an emergency call apparatus of a mobile terminal according to an exemplary embodiment.

Referring to FIGS. 1 and 2, according to an exemplary embodiment of a data flow of an emergency call apparatus of a mobile terminal, an emergency situation manager 110 first identifies voices and movements in 201. A voice signal is identified by analyzing surrounding situation sounds collected from a voice collecting device 10, which is equipped in the mobile terminal. More specifically, the emergency situation manager, in the background, continuously receives all the sounds generated from user's surroundings from the voice collecting device 10, analyzes the received surrounding situation sounds, and identifies the voice signal included in the received surrounding situation sounds. Also, the emergency situation manager 110 analyzes movement data received through a movement detecting device 20, and identifies the movement of the user who is carrying the mobile terminal. The emergency situation manager 120 identifies the movement of the user carrying the mobile terminal based on the movement data measured by the movement detecting device 20.

If the voices and movements are identified, the emergency situation manager 110 determines whether an emergency situation has occurred based on the identified voices and movements in 202. More specifically, the emergency situation manager 110 extracts a phrase with respect to the emergency situation by comparing the identified voice signal with emergency situation phrase information stored in advance. The emergency situation phrase information stored in advance may be input directly by a user, or already be basic setting. If the phrase related to an emergency situation is identified, the emergency situation manager 110 may determine that an emergency situation has occurred to the user who is carrying the mobile terminal. In addition, the emergency situation manager 110 determines whether the user's movement is unusual by comparing the user's pattern information, which is stored in advance, with the user's identified movement. The user's pattern information stored in advance is a standard to determine whether the user's present movement is normal or not when compared to the mobile terminal's movement measured through the movement detecting device 20. Therefore, the emergency situation manager 110 compares the user's movement, which is identified through the movement detecting device 20, with the user's pattern information, and if the user's movement is determined to be excessively different from the normal movement pattern within a short time, then the emergency situation manager 110 determines that the emergency situation has occurred to the user.

As described above, the emergency situation may be determined by recognizing the voices and movements of the user. The emergency situation occurrence may be determined by using either voice recognition or movement recognition independently, but if the two are used in parallel, incorrect determination of an emergency situation may be reduced. For example, if it is determined first that the emergency situation has occurred by recognizing the user's voices, then whether the movement of the user is normal or not is determined. However, if it is determined that an emergency situation has occurred through both the voice and movement recognition of the user, then it is determined that an emergency situation has occurred to the user.

If it is determined that an emergency situation has occurred, the emergency situation manager 110 transfers an emergency situation alerting signal to a controller 130 in 203. Then, the emergency situation manager 110 stores surrounding situation sounds, which are being received, in a storage device equipped in the emergency situation manager 110 while transferring the emergency situation alerting signal to the controller 130.

A location identifier 120 continuously identifies the location of the user through a location detecting device 30 in 204. The location identifier 120 identifies a present location of the user carrying the mobile terminal, based on the mobile terminal's location data received from a location tracking device 30, such as a Global Positioning System (GPS), in 204, and then transfers the identified location information of the user to the controller 130 in 205. Also, the location identifier 120 continuously stores the user's location information. According to an exemplary embodiment, because the user may go indoors, or enter areas with severe disturbance to satellite electric waves, and the like, the present location of the user may not be detected normally by the location tracking device 30. Thus, by providing not only the user's present location information, but also the user's latest location information, which is normally confirmed, the location identifier 120 may provide the closest approximate location information of the user, even when the user's current location is unclear. The process, where the location identifier 120 identifies the user's location and transfers its information to the controller 130, does not need to be executed actually in a specific step, but needs to be executed continuously in the background of a mobile terminal. So the operations 204 and 205 are positioned after the operation 203; however, this is just an exemplary embodiment for convenience of a description, but is not limited to a specific position or order, and may be continuously executed all the way throughout the whole of the operations.

Prior to notifying the emergency situation to a situation room 90, the controller 130 operates only a microphone function, and stops a speaker function in 206. By those operations, the controller 130 notifies the situation room 90 of the emergency situation in which the user is involved, and the user's location information, and avoids transferring voices generated from the situation room 90 to the user's surroundings through the mobile terminal during a process of transferring the surrounding situation sounds of the user to the situation room 90. That is because an assailant may become aware that a mobile call is connected to the situation room 90 if any sound is generated from the mobile terminal.

After receiving the emergency situation alerting signal from the emergency situation manager, the controller 130 notifies the situation room 90 of the emergency situation and the user's location information that is preset to the situation room 90 in 207. If the emergency situation alerting signal is received, the controller 130 takes action in response to the emergency situation occurrence. First, the controller 130 notifies the preset situation room 90 of the emergency situation occurrence through a communication interface of the mobile terminal. The preset situation room 90 is where notification of the emergency situation occurrence is sent, and where a signal for help is transferred, including public agencies in charge of public peace, such as a police station, a police substation, or emergency dispatch, as well as numbers, such as the user's home or parents' home phone number, which were directly input by the user. The controller 130 notifies the situation room 90 of the emergency situation occurrence, and simultaneously transfers the user's location information to the situation room 90. The user's location information is greatly important in rescuing the user who is in the emergency situation. The controller 130 may effectively respond to the emergency situation by providing the user's location information together. The controller 130 may notify the situation room 90 of the emergency situation and the user's location information by using data communications, a Short Message Service (SMS), and a mobile communication interface, etc.

Then, the emergency situation manager 110 transfers the collected surrounding situation sounds to the controller 130 in 208. If it is determined that an emergency situation has occurred by the operation 202, the emergency situation manager 110 stores and transfers the surrounding situation sounds to the controller 130.

Then, if the surrounding situation sounds are received from the emergency situation manager 110, the controller 130 makes a voice call connection to the situation room 90 in 209. Thus, if the voice call is connected to the situation room 90, the controller 130 transfers the surrounding situation sounds to the situation room 90 through the connected voice call in 210. The situation room 90 may more effectively take action in response to the emergency situation, in which the user is involved, by using the received surrounding situation sounds. The surrounding situation sounds may be transferred by connecting the voice call to the situation room 90 through the mobile communication interface that is equipped in the mobile terminal.

Also, if determined that an emergency situation is occurring to a user based on the received emergency situation alerting signal, the controller 130 takes the above-described action, and controls the mobile terminal not to show signs that the user's mobile is taking the above-described action. The controller 130 may never display those operations being operated on the mobile terminal, and just execute those operations in the background so that the assailant cannot become aware that the emergency call is in progress. For example, although the mobile terminal takes action in response to the emergency situation occurrence that is described above, such action is executed in the background so that various functions of the mobile terminal can be normally used while hiding that the emergency call is in progress and showing the same as normal standby status.

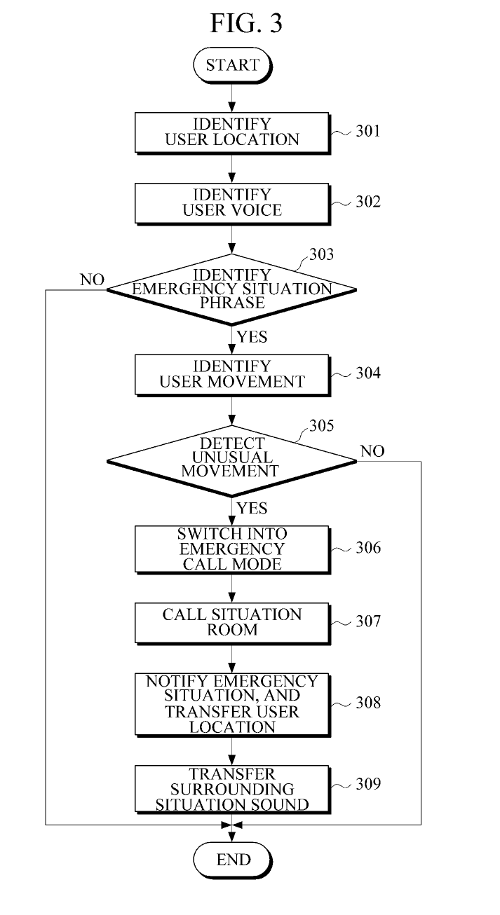

FIG. 3 is a diagram illustrating an example of an emergency call method of a mobile terminal according to an exemplary embodiment.

Referring to FIG. 3, a call method of a mobile terminal according to an exemplary embodiment first includes identifying the user's location after collecting location information of a user in 301. The user's location may be continuously collected through a location tracking device equipped in the mobile terminal, and the collection of the user's location data may be stored. The collection of the user's location data may enable more effective action by notifying the situation room of the user's exact location when an emergency situation occurs. According to an exemplary embodiment, because the user may go indoors, or enter areas with severe disturbance of satellite electric waves, and the like, the present location of the user may not be detected normally through the location tracking device 30. Thus, by providing not only the user's present location information, but also the user's latest location information normally confirmed, the closest approximate location information of the user may be provided, even when the user's current location is unclear. The process of which the location identifier identifies the user's location and transfers its information to the controller does not need to be executed actually in a certain step, but may be executed continuously in a background application of the mobile terminal.

Then, voices of the user are identified in 302. Surrounding situation sounds generated from the surroundings of a mobile terminal are continuously collected through a voice collecting device equipped in the mobile terminal, and the user's voices are identified from the collected surrounding situation sounds. Then, whether an emergency situation phrase is detected in the identified voices of the user is checked in 303. By comparing a signal of the identified voices with emergency situation phrase information stored in advance, a phrase of the emergency situation is identified. The emergency situation phrase information stored in advance may be input directly by a user, or be already a basic setting. If the phrase with respect to the emergency situation is not identified, then it is determined that the emergency situation has not occurred, and the emergency call method of the mobile terminal is ceased.

Otherwise, if the phrase with respect to an emergency situation is identified, then a user's movement is identified in 304, and whether an unusual movement is detected in the identified movement of the user may be determined in 305. Only with the emergency situation phrase identified from the user's voices, it may be determined that an emergency situation has occurred to the user. However, in such case, it is more likely that an error may be generated when determining the emergency situation. That is because the emergency phrase is identified regardless of the emergency situation occurrence. For example, in a case where the phrase ‘help me’ is included among the emergency situation phrases, the ‘help me’ can be also used when asking for simple help in everyday life, not only in emergency situations. If such case is determined that an emergency situation has occurred, various problems may be generated, such as a problem of incorrectly transferring an emergency situation notification, and the like. Thus, if the emergency situation phrase is identified by the user's voice recognition, and then an unusual movement pattern is detected and checked from the identified movement of the user, incorrect determination of an emergency situation occurrence may be reduced.

A method of detecting the unusual movement from the identified movement of a user entails determining whether the user's movement is unusual by comparing the user's pattern information and the identified movement of the user. The user's pattern information stored in advance is a standard to determine whether the user's present movement is normal or not, compared to the mobile terminal's movement measured through the movement detecting device. Therefore, the emergency situation manager may compare the user's movement, which is identified through the movement detecting device, with the user's pattern information, and if the user's movement is determined to be excessively different from the normal movement pattern within a short time, the emergency situation manager may determine that the user is in an emergency situation. Otherwise, if unusual movement is not detected, then it is determined that an emergency situation has not occurred, and the emergency call method of the mobile is ceased.

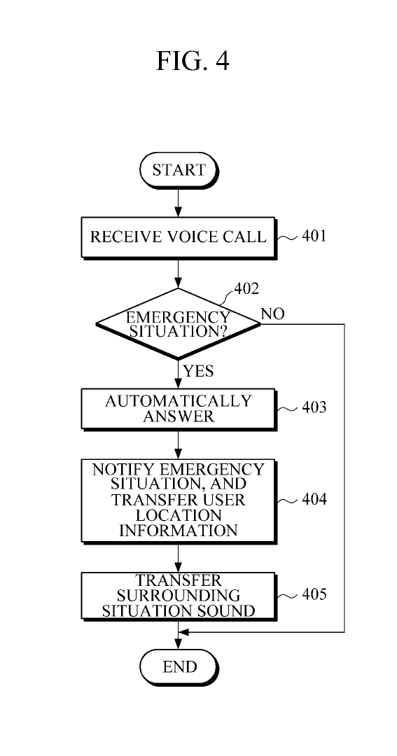

If unusual movement is detected, it is determined that an emergency situation has occurred, and an emergency call apparatus is switched into the emergency call mode in 306. The emergency call mode indicates a state where the microphone of the mobile terminal turns on, and the speaker off. Prior to notifying the situation room of the emergency situation, only the microphone function of the mobile terminal is operated, and the speaker function is stopped. By switching the mobile terminal into the emergency call mode, the emergency call method notifies the situation room of the emergency situation occurring to the user and the user's location information, and avoids transferring voices generated from the situation room to the user's surroundings through the mobile terminal during a process of transferring the surrounding situation sounds of the user to the situation room. That is because an assailant may become aware that the mobile call is connected to the situation room 90 if any sound is generated from the mobile terminal. In addition, if an incoming call is received in a state where the mobile terminal has detected an emergency situation occurrence, the call is automatically received, and both the emergency situation occurrence and the user's location information are transferred to a caller. A process for the incoming call generation in the emergency call mode is described later in FIG. 4.

If switched into the emergency call mode, the situation room is called to transfer the rescue request in response to the emergency situation occurrence in 307. Then, the emergency situation and the user's location information are sent to the situation room in 308. If switched into the emergency situation mode after determining that an emergency situation has occurred, first the preset situation room is notified of the emergency situation through the communication interface of the mobile terminal in response to the emergency situation occurrence. The preset situation room is where the fact that an emergency situation has occurred is sent, and where the signal for help is transferred, including public agencies in charge of public peace, such as a police station, a police substation, and emergency dispatch, as well as numbers, such as the user's or parents' home numbers, which were directly input by the user. The user's location information is transferred to the situation room while executing such operations. The user's location information is greatly important in rescuing the user who is in an emergency situation. The emergency call apparatus may effectively take action in response to the emergency situation by providing the user's location information together. The controller may notify the situation room of the emergency situation and the user's location information by using the data communication, a Short Message Service (SMS), and a mobile communication interface, etc.

Then, surrounding situation sounds that are collected is transferred in 309. The surrounding situation sounds are transferred to the situation room through a voice call connection between the situation room and the mobile terminal. The situation room may more effectively respond to the emergency situation in which the user is involved, by using the surrounding situation sounds. The surrounding situation sounds may be transferred by connecting the voice call to the situation room 90 through the mobile communication interface that is equipped in the mobile terminal.

FIG. 4 is a diagram illustrating an example of a response method when receiving an emergency call of a mobile terminal according to an exemplary embodiment.

Referring to FIG. 4, a response method to receive an incoming call when an emergency situation occurs is illustrated according to an exemplary embodiment of an emergency call method of a mobile terminal. At first, if the voice call is received externally in 401, then whether an emergency situation has occurred is determined in 402. If an emergency situation does not occur, the emergency call method ends. However, if an emergency situation occurs, the mobile terminal is switched into the emergency call mode. By such operation, it may be determined that an emergency situation has occurred.

If an emergency situation occurs, and then the mode is switched into the emergency call mode, an automatic response is executed for the emergency situation occurrence without the incoming call ringtone in response to receiving the call in 403. If the incoming call ringtone rings during an emergency situation, the user may be placed in danger. So, when a call is received in the emergency call mode, the automatic response is executed to inform the emergency situation without the incoming call ringtone. The emergency situation is alerted to the caller called through the automatic response execution, and the user's location information is transferred as well in 404. If the emergency situation is notified to the caller through the automatic response execution, the caller may recognize that the user is in an emergency situation, and take action in response to the emergency situation. The received location information of the user is necessary to take effective action in response to the emergency situation occurrence. Then, the surrounding situation sounds collected through the microphone of the mobile terminal is transferred to the caller in 405. The caller may monitor a site situation through the mobile terminal microphone of the user. By those operations, the caller may more exactly identify the emergency situation occurring to the user, and take appropriate action.

According to an exemplary embodiment, an emergency call apparatus of a mobile terminal and an emergency call service may identify movements and voices of the user without an additional operation, and determine whether an emergency situation is occurring. Also, the emergency call apparatus and the emergency call service may reduce error occurrence by determining whether an emergency situation exists by using both the movements and voices of the user. In addition, by transferring the location information and surrounding situation sounds of the user to the situation room, the situation room may specifically identify the situation in which the user is involved, in order to effectively take action.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An emergency call apparatus of a mobile terminal, the emergency call apparatus comprising:
a location identifier configured to identify a location of a user, and generate location information of the user;
an emergency situation manager configured to identify both voices and movements of the user, determine whether an emergency situation is occurring based on the identified voices and movements, generate an emergency situation alerting signal based on the determination result, and collect surrounding situation sounds generated around the user; and
a controller configured to notify a situation room of the occurrence of the emergency situation based on the emergency situation alerting signal, and transfer the location information of the user and the surrounding situation sounds of the user to the situation room.

2. The emergency call apparatus of a mobile terminal of claim 1, wherein the emergency situation manager compares the identified voices of the user and preset emergency situation phrase information, identifies an emergency situation phrase, and determines whether the emergency situation is occurring through the identified emergency situation phrase.

3. The emergency call apparatus of a mobile terminal of claim 1, wherein the emergency situation manager compares the identified movements of the user and preset user pattern information, and in response to the comparison result that movements of a different pattern compared to the preset user pattern information are detected among the movements of the user within a short time, determines that the emergency situation is occurring.

4. The emergency call apparatus of a mobile terminal of claim 1, wherein in response to the occurrence of the emergency situation, the controller turns on either a microphone or a transmitter of the mobile terminal, and turns off a speaker and a receiver of the mobile terminal.

5. The emergency call apparatus of a mobile terminal of claim 1, wherein the location identifier continuously stores the location information of the user, and in response to not identifying the location of the user, transfers location information of the user, which is most recently identified, to the controller.

6. The emergency call apparatus of a mobile terminal of claim 1, wherein the surrounding situation sounds are transferred to the situation room through a voice call connection

7. The emergency call apparatus of a mobile terminal of claim 1, wherein the controller notifies the situation room of the occurrence of the emergency situation, and executes in a background a process of transferring the location information of the user and the surrounding situation sounds.

8. The emergency call apparatus of a mobile terminal of claim 1, wherein in response to reception of an incoming call during the emergency situation, the controller automatically receives the incoming call without an incoming call ringtone and transfers the occurrence of the emergency situation to a caller.

9. An emergency call method of a mobile terminal, the emergency call method comprising:
identifying a location of a user, and generating location information of the user;
identifying both voices and movements of the user;
determining whether an emergency situation is occurring based on the identified voices and movements of the user; and
in response to determining that the emergency situation is occurring, notifying a situation room of the occurrence of the emergency situation, and transferring the location information of the user and the surrounding situation sounds of the user to the situation room.

10. The emergency call method of the mobile terminal of claim 9, wherein the determining of whether the emergency situation is occurring based on the identified voices and movements of the user comprises:
comparing the identified voices of the user and preset emergency situation phrase information, and identifying an emergency situation phrase;
in response to identification of the emergency situation phrase, comparing the identified movements of the user and preset user pattern information, and detecting movements of a different pattern compared to the preset user pattern information among the movements of the user within a short time.

11. The emergency call method of the mobile terminal of claim 9, further comprising:
in response to determination of the occurrence of the emergency situation, turning on at least either a microphone or a transmitter of the mobile terminal, and turning off a speaker and a receiver of the mobile terminal.

12. The emergency call method of the mobile terminal of claim 9, wherein the identifying of the location of the user, and the generating of the location information of the user comprise continuously storing the location information of the user, and in response to not identifying the location of the user, setting location information of the user, which is most recently stored, as the location information.

13. The emergency call method of the mobile terminal of claim 9, wherein the surrounding situation sounds are transferred to the situation room through a voice call connection.

14. The emergency call method of the mobile terminal of claim 9, wherein the notifying and the transferring are executed in a background of the mobile terminal.

15. The emergency call method of the mobile terminal of claim 9, wherein in response to reception of an incoming call when the emergency situation occurs, the controller automatically receives the incoming call without an incoming call ringtone and transfers the occurrence of the emergency situation to a caller.
